(19) United States
(12) Patent Application Publication
(10) Pub. No.: US 2017/0120819 A1
(43) Pub. Date: May 4, 2017

(54) INFORMATION DISPLAY CONTROL SYSTEM AND METHOD OF CONTROLLING DISPLAY OF INFORMATION

(71) Applicant: MITSUBISHI ELECTRIC CORPORATION, Tokyo (JP)

(72) Inventors: Hidekazu ARITA, Tokyo (JP); Mitsuo SHIMOTANI, Tokyo (JP)

(73) Assignee: MITSUBISHI ELECTRIC CORPORATION, Tokyo (JP)

(21) Appl. No.: 15/317,522

(22) PCT Filed: Sep. 29, 2014
(86) PCT No.: PCT/JP2014/075810

§ 371 Date: Dec. 9, 2016

(51) Int. Cl. B60R 1/00

(52) U.S. Cl. CPC B60R 1/00; B60R 2300/205

(57) ABSTRACT

An information display control system includes: a display controller that makes a display unit of an own vehicle display an image; an own vehicle position acquiring part that acquires position information about the own vehicle; a feature data acquiring part that acquires feature data including position information about a feature; and a difficult-to-visually-recognize feature detector that detects a difficult-to-visually-recognize feature that is a feature existing in a position where the feature is visually recognizable from the own vehicle but in a state of being difficult to recognize visually. The display controller makes the display unit display an image indicating the position of a difficult-to-visually-recognize feature based on the position information about the feature included in the feature data and the position information about the own vehicle acquired by the own vehicle position acquiring part.

### TECHNICAL FIELD

The present invention relates to an information display control system that displays an image on a display unit of a vehicle.

### BACKGROUND ART

An information display system such as a car navigation system including a display unit installed on a vehicle has been in widespread use. In recent years, development has been made toward practical use of a transmissive display unit (such as a head-up display) that displays information directly in the field of view of a driver by displaying the information on a windshield or a transparent screen that provides the driver with a see-through view (see patent document 2 listed below, for example).

Patent document 1 listed below discloses a technique according to which, in the presence of a region of a low level of clarity in an image of a surrounding of an own vehicle to be displayed by a vehicle display device, an image of a surrounding of the own vehicle previously captured is superimposed on the former image and then a resultant image is displayed. Patent document 2 listed below discloses a technique of displaying a lane guide indicating the shape of a lane in which an own vehicle is traveling on a display device that displays an image through the windshield of a vehicle. In particular, patent document 2 suggests a technique according to which, in the presence of an interference such as a side ditch extending along a lane in which an own vehicle is traveling, a driver is notified of the presence of the interference by displaying a lane guide indicating the shape of the lane in which the own vehicle is traveling in a color different from a usual color.

### PRIOR-ART DOCUMENTS

### Patent Documents

Patent Document 1: International Publication No. 2013/171962

Patent Document 2: Japanese Patent Application Laid-Open No. 2006-350617

### SUMMARY OF INVENTION

### Problems to be Solved by Invention

In a situation where the visibility of a feature in a neighborhood of a vehicle is reduced due to snow cover, rain, or fog, for example, a driver is likely to delay in finding the existence of the feature to cause risk of interference with driving of the vehicle. Hence, a technique of making the driver promptly recognize the existence of the feature of reduced visibility has been desired. A “feature” mentioned in the present description shows a concept covering every object existing in the real world including a planar object such as a road marking drawn on a road (traffic sign or lane marking), for example.

The present invention has been made to solve the aforementioned problem. It is an object of the present invention to provide an information display control system that allows a driver to recognize the position of a feature in a state of being difficult to recognize visually.

### Means of Solving Problems

An information display control system according to the present invention includes: a display controller that makes a display unit of an own vehicle display an image; an own vehicle position acquiring part that acquires position information about the own vehicle; a feature data acquiring part that acquires feature data including position information about a feature; and a difficult-to-visually-recognize feature detector that detects a difficult-to-visually-recognize feature that is a feature existing in a position where the feature is visually recognizable from the own vehicle but in a state of being difficult to recognize visually. The display controller makes the display unit display an image indicating the position of a difficult-to-visually-recognize feature based on the position information about the feature included in the feature data and the position information about the own vehicle acquired by the own vehicle position acquiring part.

### Advantageous Effect of Invention

The present invention allows a driver to recognize the position of a feature in a state of being difficult to recognize visually, thereby assisting in driving.

These and other objects, features, aspects and advantages of the present invention will become more apparent from the following detailed description and the accompanying drawings.

### BRIEF DESCRIPTION OF DRAWINGS

FIG. 1 is a block diagram showing the structure of an information display control system according to a first embodiment.

FIG. 2 explains the operation of an information display control device according to the first embodiment.

FIG. 3 explains the operation of the information display control device according to the first embodiment.

FIG. 4 explains the operation of the information display control device according to the first embodiment.

FIG. 5 explains the operation of the information display control device according to the first embodiment.

FIG. 6 is a flowchart showing the operation of the information display control device according to the first embodiment.

FIG. 7 is a block diagram showing the structure of an information display control system according to a second embodiment.

FIG. 8 explains the operation of an information display control device according to the second embodiment.

FIG. 9 explains a modification of the operation of the information display control device according to the second embodiment.

FIG. 10 is a block diagram showing the structure of an information display control system according to a third embodiment.

FIG. 11 is a block diagram showing the structure of an information display control system according to the third embodiment.

FIG. 12 is a block diagram showing the structure of an information display control system according to a fourth embodiment.

FIG. 13 explains the operation of an information display control device according to the fourth embodiment.

FIG. 14 is a flowchart showing the operation of the information display control device according to the fourth embodiment.

FIG. 15 is a block diagram showing the structure of an information display control system according to a fifth embodiment.

FIG. 16 is a block diagram showing the structure of an information display control system according to a sixth embodiment.

FIG. 17 explains an exemplary method of indicating the position of a feature by using an image displayed by a display unit.

FIG. 18 explains an exemplary method of indicating the position of a feature by using an image displayed by a transmissive display unit.

### DESCRIPTION OF EMBODIMENT(S)

### First Embodiment

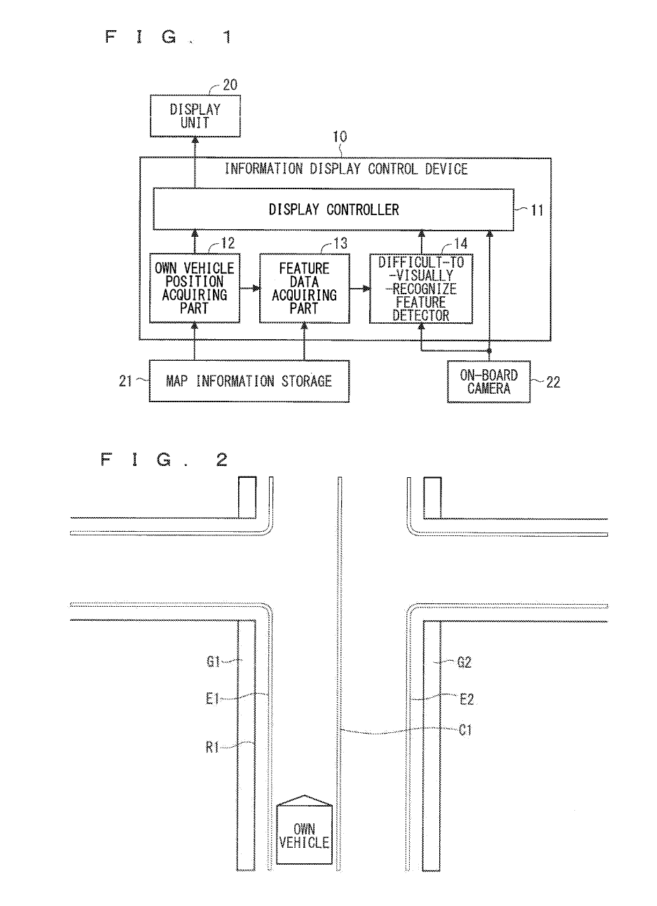

FIG. 1 is a block diagram showing the structure of an information display control system according to a first embodiment. As shown in FIG. 1, the information display control system includes an information display control device 10, a display unit 20, a map information storage 21, and an on-hoard camera 22. In this structure, the display unit 20, the map information storage 21, and the on-board camera 22 are attached externally to the information display control device 10. Alternatively, the display unit 20, the map information storage 21, and the on-board camera 22 may be integral with the information display control device 10.

The display unit 20 is formed of a liquid crystal display device, for example. The display unit 20 of this embodiment is installed on a vehicle. However, the display unit 20 is not limited to a display unit fixed in a vehicle such as a display part of an instrument panel but it may also be a portable display device that can be brought into a vehicle (such as a television terminal, a smartphone, or a tablet terminal, for example).

The map information storage 21 is a storage medium such as a hard disk or a removal medium storing map information. Map information stored in the map information storage 21 includes not only data about a road network but also feature data including position information about a feature existing everywhere and information about the type of this feature. The map information storage 21 may also be a server that provides map information to the information display control device 10 through a communication network such as the Internet.

The on-board camera 22 is an image capturing device that captures an image of a surrounding of a vehicle on which the information display control device 10 and the display unit 20 are installed (hereinafter called an “own vehicle”).

The information display control device 10 is a control device that controls the operation of the display unit 20. The information display control device 10 includes a display controller 11, an own vehicle position acquiring part 12, a feature data acquiring part 13, and a difficult-to-visually-recognize feature detector 14. The information display control device 10 is configured by using a computer. The display controller 11, the own vehicle position acquiring part 12, the feature data acquiring part 13, and the difficult-to-visually-recognize feature detector 14 are realized by the operation of the computer according to a program.

The display controller 11 generates an image signal to be used for making the display unit 20 display an image, thereby making the display unit 20 display an intended image. For example, the display controller 11 can acquire an image captured by the on-board camera 22 and make the display unit 20 display the captured image.

The own vehicle position acquiring part 12 acquires position information about an own vehicle. A representative example of the own vehicle position acquiring part 12 is a GNSS (global navigation satellite system) receiver that receives a signal from a GNSS such as a GPS (global positioning system) to acquire information about an absolute position (in terms of a latitude or a longitude). The own vehicle position acquiring part 12 may also include a speed sensor or a direction sensor for acquiring information about a relative position (position change). The own vehicle position acquiring part 12 can increase the accuracy of position information about the own vehicle by performing a map matching process using the map information stored in the map information storage 21.

The own vehicle position acquiring part 12 is not always required to have the function of calculating the position of an own vehicle but may be configured to acquire position information about the own vehicle from a different system (such as a navigation system) to handle position information about the own vehicle.

The feature data acquiring part 13 detects a feature existing in a neighborhood of an own vehicle (in a range of a given distance from the position of the own vehicle, for example) based on the position information about the own vehicle acquired by the own vehicle position acquiring part 12 and the map information stored in the map information storage 21, and acquires data about the detected feature.

The difficult-to-visually-recognize feature detector 14 detects a feature existing in a position where the feature is visually recognizable from the own vehicle but in a state of being difficult to recognize visually (hereinafter called a “difficult-to-visually-recognize feature”) based on position information about the feature included in the feature data acquired by the feature data acquiring part 13 and an image of a surrounding of the own vehicle (captured image) captured by the on-board camera 22. More specifically, the difficult-to-visually-recognize feature detector 14 extracts an image of a position where the feature exists from the image of the surrounding of the own vehicle captured by the on-board camera 22, analyzes the extracted image, and determines whether or not an image of the feature has been captured clearly by the on-board camera 22. If this image has not been captured clearly, the feature is detected as a difficult-to-visually-recognize feature.

The display controller 11 determines a relationship in terms of position between the own vehicle and the difficult-to-visually-recognize feature based on the position information about the own vehicle and the position information included in the feature data about the difficult-to-visually-recognize feature. Then, the display controller 11 superimposes the image indicating the position of the difficult-to-visually-recognize feature on the image of the surrounding of the own vehicle captured by the on-board camera 22 and makes the display unit 20 display a resultant image. Further, the display controller 11 determines the content of the image indicating the position of the difficult-to-visually-recognize feature (shape, pattern, or color) in a manner that depends on the type of the feature.

In this embodiment, the on-board camera 22 is to capture an image of a place ahead of an own vehicle in a traveling direction. The display controller 11 is to make the display unit 20 display an image indicating the position of a difficult-to-visually-recognize feature being one of difficult-to-visually-recognize features detected by the difficult-to-visually-recognize feature detector 14 and existing in a range of image capturing by the on-board camera 22 (specifically, existing ahead of the own vehicle in the traveling direction) (the difficult-to-visually-recognize feature detector 14 may detect only a difficult-to-visually-recognize feature existing ahead of the own vehicle in the traveling direction).

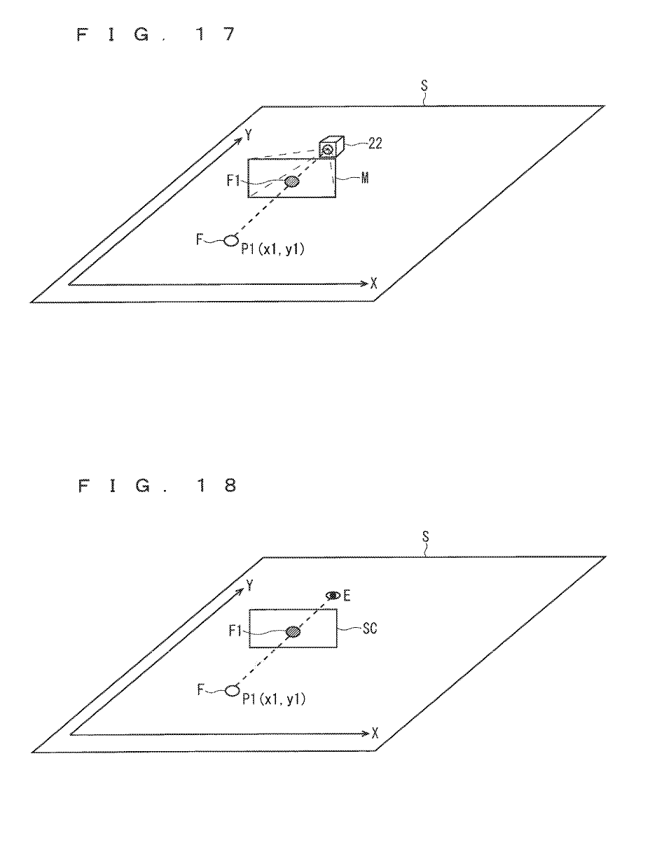

In this embodiment, the display controller 11 combines an image indicating the existence of a difficult-to-visually-recognize feature with a part of an image of a surrounding of an own vehicle that corresponds to a position where the difficult-to-visually-recognize feature exists to create a composite image. Then, the display controller 11 makes the display unit 20 display the composite image, thereby indicating the position of the difficult-to-visually-recognize feature. FIG. 17 conceptually shows this method.

It is assumed, for example, that a ground surface S is a plane including an X axis and a Y axis, as shown in FIG. 17. If a feature F as a difficult-to-visually-recognize feature exists in a position P1 (x1, y1) on the ground surface S, the display controller 11 combines an image F1 indicating the existence of the feature F with a part of an image M of the ground surface S captured by the on-board camera 22 that corresponds to the position P1 (x1, y1). In an image displayed on the display unit 20 through the use of this method, the position of the image F1 agrees with the position where the feature F exists. Thus, a driver of an own vehicle is allowed to recognize the position where the difficult-to-visually-recognize feature exists correctly based on the position where the image F1 is displayed.

Next, the operation of the information display control device 10 according to the first embodiment is descried in detail. If detecting the presence of a difficult-to-visually-recognize feature ahead of an own vehicle in a traveling direction, the information display control device 10 operates to superimpose an image indicating the position of the detected difficult-to-visually-recognize feature on an image captured by the on-board camera 22 and make the display unit 20 display a resultant image.

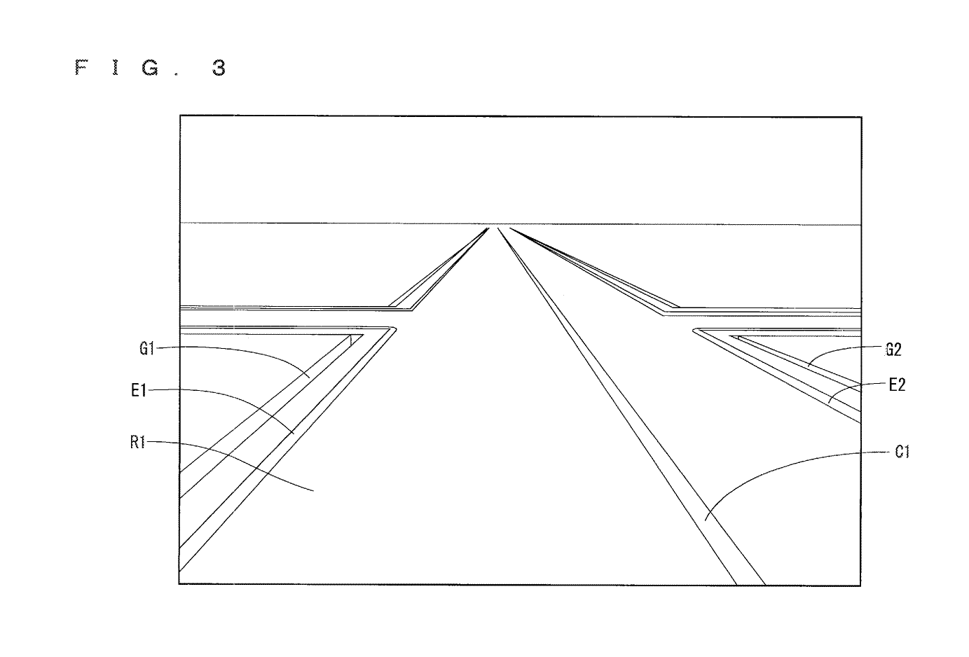

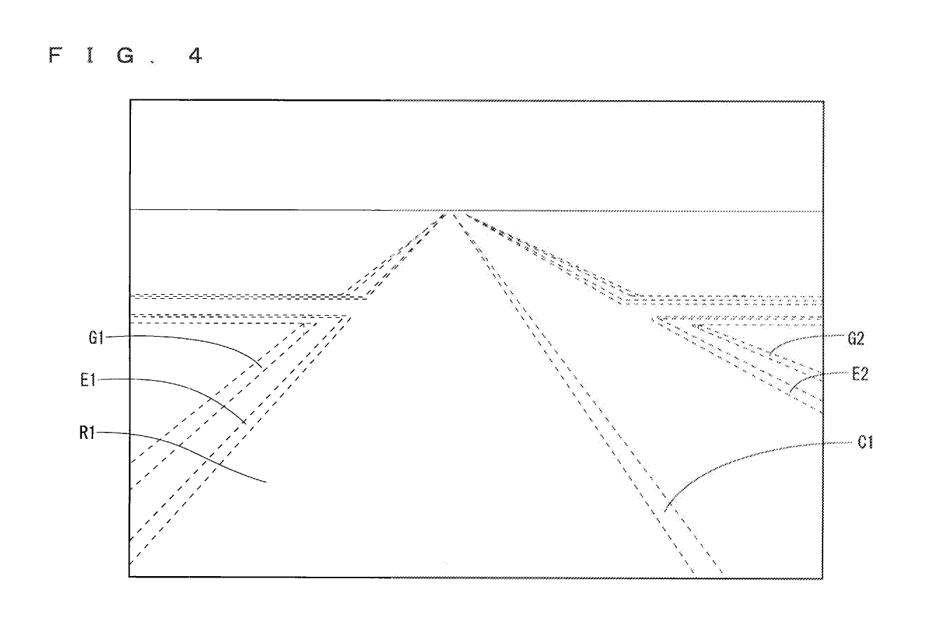

It is assumed, for example, that the own vehicle is traveling on a road R1 shown in FIG. 2. In this example, a center line C1, a roadway edge line E1, and a roadway edge line E2 (hereinafter simply called an “edge line”) are drawn on the road R1, and a side ditch G1 and a side ditch G2 are provided at opposite sides of the road R1. With good visibility, an image such as that shown in FIG. 3 is captured by the on-board camera 22.

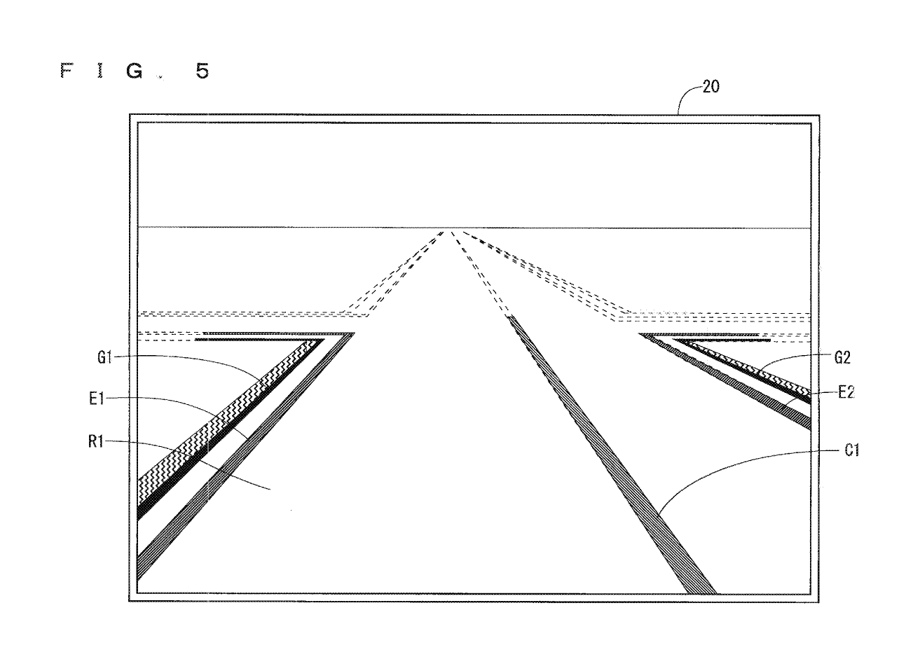

Meanwhile, if the road R1 is covered with snow to place each of the road R1, the center line C1, the edge lines E1 and E2, and the side ditches G1 and G2 in a state of being difficult to recognize visually, these features are not clearly shown in an image captured by the on-board camera 22, as shown in FIG. 4. In this case, the difficult-to-visually-recognize feature detector 14 of the information display control device 10 detects the road R1, the center line C1, the edge lines E1 and E2, and the side ditches G1 and G2 as difficult-to-visually-recognize features. Then, as shown in FIG. 5, the display controller 11 superimposes images indicating the respective positions of the road R1, the center line C1, the edge lines E1 and E2, and the side ditches G1 and G2 as difficult-to-visually-recognize features on the image (FIG. 4) captured by the on-board camera 22, and makes the display unit 20 display a resultant image.

Each of the images indicating the respective positions of the center line C1, the edge lines E1 and E2, and the side ditches G1 and G2 on a screen of the display unit 20 is illustrated as indicating a position and a shape same as an actual position and an actual shape of a corresponding feature. However, the position and the shape indicated by each of these images are not necessarily required to agree with those of an actual feature. In the illustration of FIG. 5, for example, in the image indicating the position of the road R1, the road R1 is represented by a contour.

A driver of an own vehicle can easily recognize the width of the road R1 and the respective positions of the center line C1, the edge lines E1 and E2, and the side ditches G1 and G2 by seeing the image (FIG. 5) displayed on the display unit 20.

In the aforementioned example, a difficult-to-visually-recognize feature is caused by snow cover. The aforementioned example is further applicable to a state where a feature becomes difficult to recognize visually caused by immersion in water or dense fog, or to a state where a road marking becomes difficult to recognize visually caused by wear of a road surface and resultant fading of the road marking.

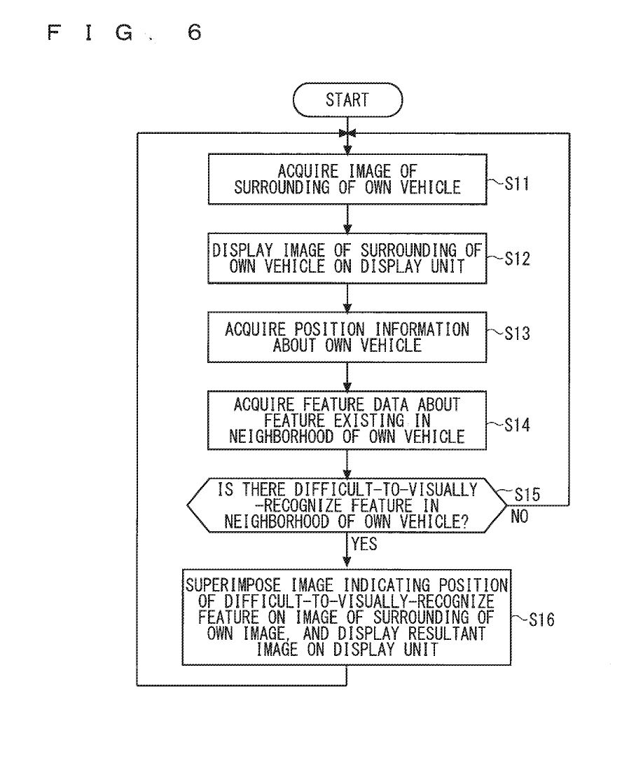

FIG. 6 is a flowchart showing the operation of the information display control device 10 according to the first embodiment. The operations described by referring to FIGS. 2 to 5 are realized by implementation of processes shown in FIG. 6 by the information display control device 10. The processes of FIG. 6 are finished in response to an action for finishing these processes taken by a user on the information display control device 10, input of a command given from a different device instructing finish of these processes to the information display control device 10, or receipt of a command instructing finish of these processes given from a different process performed by the information display control device 10, for example.

When the information display control device 10 is started, the display controller 11 first acquires an image of a surrounding of an own vehicle captured by the on-board camera 22 (step S11), and makes the display unit 20 display the acquired image (step S12). Then, the own vehicle position acquiring part 12 acquires position information about the own vehicle (step S13), and the feature data acquiring part 13 acquires feature data about a feature existing in a neighborhood of the own vehicle from the map information storage 21 (step S14).

Next, the difficult-to-visually-recognize feature detector 14 analyzes an image of the surrounding of the vehicle (an image of a position where the feature exists) captured by the on-board camera 22 based on the feature data (position information about the feature) acquired by the feature data acquiring part 13, thereby determining whether or not there is a difficult-to-visually-recognize feature in the neighborhood of the own vehicle (step S15). If there is no difficult-to-visually-recognize feature in the neighborhood of the own vehicle (step S15: NO), the flow returns to step S11.

If there is a difficult-to-visually-recognize feature in the neighborhood of the own vehicle (step S15: YES), the display controller 11 superimposes an image indicating the position of the difficult-to-visually-recognize feature on the captured image of the surrounding of the own vehicle (image captured in step S12), and makes the display unit display a resultant image (step S16). Then, the flow returns to step S11. Specifically, the processes from steps S11 to S16 are performed repeatedly.

According to the example shown in this embodiment, an image to be displayed indicates the position of a difficult-to-visually-recognize feature existing ahead of an own vehicle in a traveling direction. Alternatively, an image indicating the position of a difficult-to-visually-recognize feature existing lateral to or behind an own vehicle may be superimposed on a captured image of a place lateral to or behind the own vehicle, and a resultant image may be displayed. For example, the present invention may be applicable to a screen for checking behind (rear monitor) to be employed during parking.

### Second Embodiment

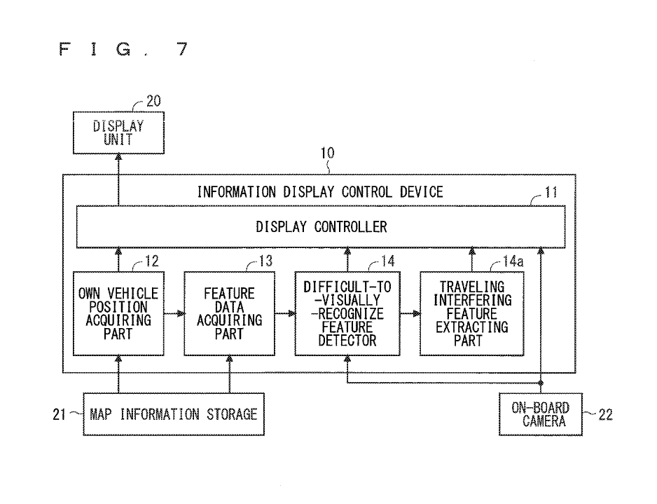

FIG. 7 is a block diagram showing the structure of an information display control system according to a second embodiment. Compared to the structure of the first embodiment (FIG. 1), this information display control system additionally includes a traveling interfering feature extracting part 14a in the information display control device 10.

The traveling interfering feature extracting part 14a extracts a feature that might be an interference with traveling of an own vehicle (hereinafter called a “traveling interfering feature”) from difficult-to-visually-recognize features detected by the difficult-to-visually-recognize feature detector 14. Referring to the road R1 of FIG. 2, for example, a feature at a different level from the road R1 such as the side ditches G1 and G2 is a traveling interfering feature. Determination as to whether or not each feature is a traveling interfering feature can be made based on the type of the feature indicated by feature data (for example, a three-dimensional feature such as a side ditch or a median strip can be determined to be a traveling interfering feature). Alternatively, feature data may contain information indicating whether or not a corresponding feature is a traveling interfering feature.

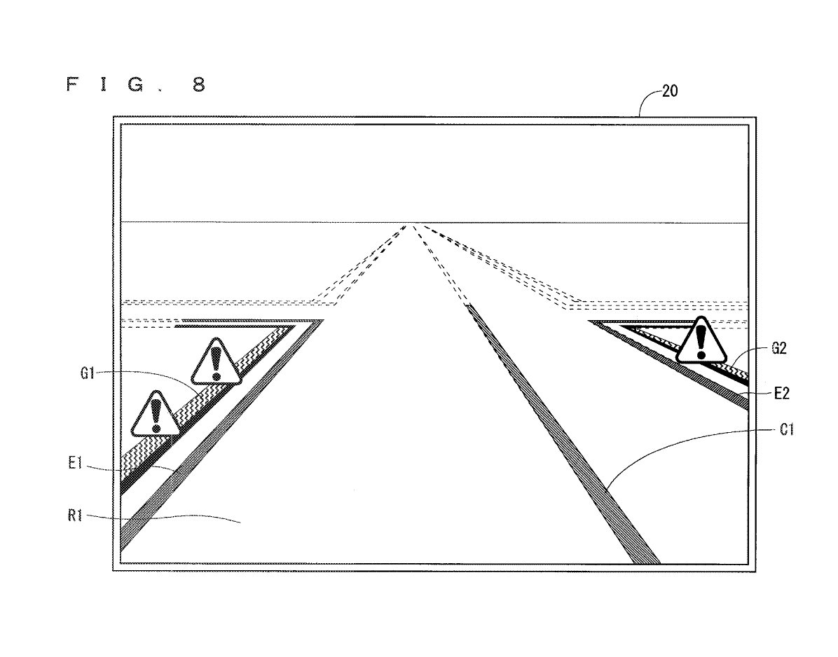

In the second embodiment, the display controller 11 incorporates an image warning about the existence of a traveling interfering feature into an image indicating the position of this traveling interfering feature extracted by the traveling interfering feature extracting part 14a. If the difficult-to-visually-recognize feature detector 14 detects the road R1, the center line C1, the edge lines E1 and E2, and the side ditches G1 and G2 as difficult-to-visually-recognize features while an own vehicle is traveling on the road R1 of FIG. 2, for example, the traveling interfering feature extracting part 14a extracts the side ditches G1 and G2 as traveling interfering features from these detected features. In this case, as shown in FIG. 8, the display controller 11 uses images warning about the existence of the side ditches G1 and G2 (here, graphic objects including symbols “!”) as images indicating the side ditches G1 and G2. This allows a driver to recognize the existence of the traveling interfering features more reliably.

An image warning about the existence of a traveling interfering feature is not limited to those shown in FIG. 8 but it may also be an image of a particular character, graphic object, color, or pattern, or motion images (flashing images, for example). What is required is to make an image indicating a traveling interfering feature more notable than an image indicating a different difficult-to-visually-recognize feature.

As shown in FIG. 9, the information display control device 10 may be configured to superimpose only an image indicating the position of a traveling interfering feature detected by the traveling interfering feature extracting part 14a on a captured image of a surrounding of an own vehicle and display a resultant image. By not displaying an image indicating a feature except a traveling interfering feature, an image indicating a traveling interfering feature can be displayed more notably.

### Third Embodiment

In the first embodiment, the difficult-to-visually-recognize feature detector 14 is configured to detect a difficult-to-visually-recognize feature based on position information about an own vehicle and an image of a surrounding of the vehicle captured by the on-board camera 22. Meanwhile, a difficult-to-visually-recognize feature may be detected by a different way. Several examples of such a different way are described herein.

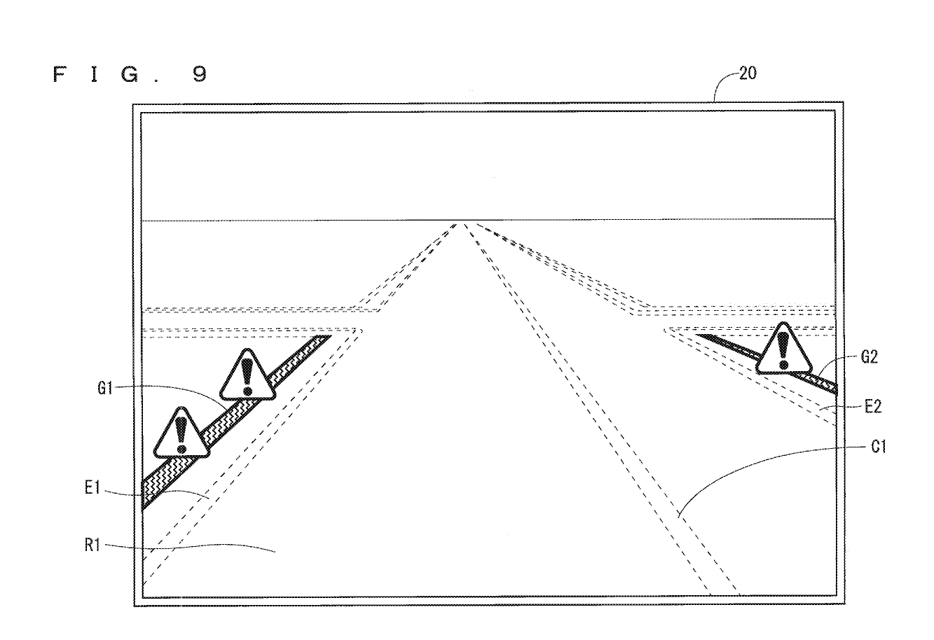

For example, the difficult-to-visually-recognize feature detector 14 may detect a difficult-to-visually-recognize feature based on information acquired by various sensors (on-board sensors) installed on an own vehicle. FIG. 10 shows an example of the structure of an information display control system employed in such a case. Compared to the structure of the first embodiment (FIG. 1), the information display control device 10 is further connected to an on-board sensor 23 (the on-board sensor 23 may be provided inside the information display control device 10).

In this structure, the difficult-to-visually-recognize feature detector 14 determines whether or not each feature detected by the feature data acquiring part 13 is difficult to recognize visually based on information indicating a state of an environment in a neighborhood of an own vehicle acquired by the on-board sensor 23 (such as an illumination sensor, a rainfall sensor, or a fog sensor, for example). If it rains or during dense fog, for example, the difficult-to-visually-recognize feature detector 14 may determine a feature existing in a position separated from the own vehicle by a given distance or more to be a difficult-to-visually-recognize feature. The other processes can be the same as those in the first embodiment, so that they will not be described herein.

As another example, if an infrastructure such as a beacon to distribute traffic information is developed and a distribution facility to distribute information about a difficult-to-visually-recognize feature (such as a faded road marking or a side ditch buried in snow, for example) is installed at each place of a road network, the difficult-to-visually-recognize feature detector 14 can detect a difficult-to-visually-recognize feature based on information acquired as a result of communication with each distribution facility.

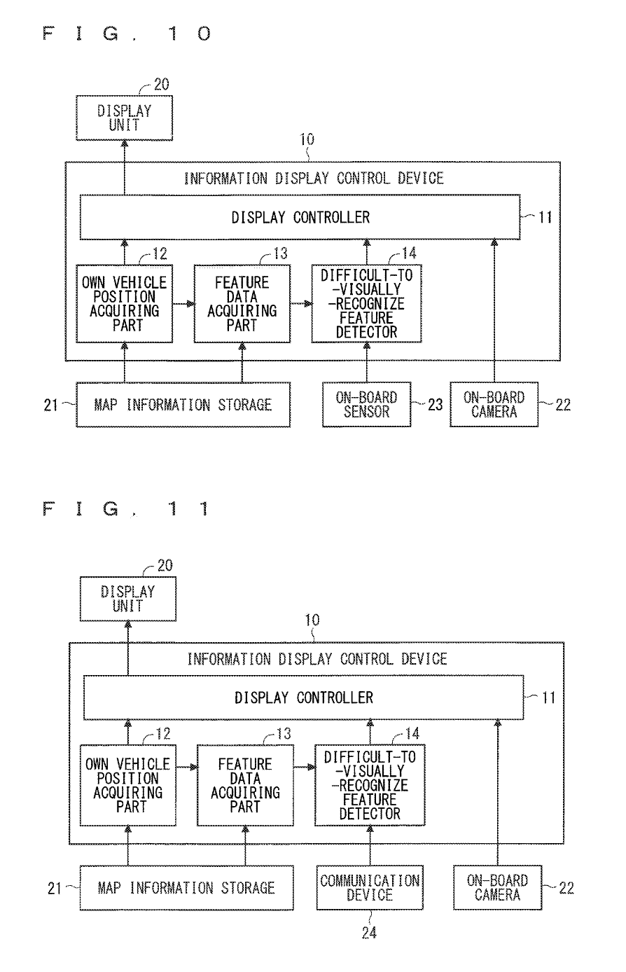

FIG. 11 is a block diagram showing the structure of an information display control system employed in such a case. A communication device 24 to make communication with an information distribution facility is connected to the information display control device 10 (the communication device 24 may be provided inside the information display control device 10).

The information display control device 10 makes communication by using the communication device 24 to acquire information about a difficult-to-visually-recognize feature from an information distribution facility. Then, the difficult-to-visually-recognize feature detector 14 compares position information about the difficult-to-visually-recognize feature acquired by the communication device 24 from the distribution facility and position information about a feature in a neighborhood of an own vehicle detected by the feature data acquiring part 13 to determine whether or not each feature is a difficult-to-visually-recognize feature. The other processes can be the same as those in the first embodiment.

Additionally, the technique of using the on-board camera 22, the technique of using the on-board sensor 23, or the technique of using the communication device 24 may be used in combination. For example, the technique of using the communication device 24 may be employed in a region where an information distribution facility is developed. The technique of using the on-board camera 22 or the on-board sensor 23 may be employed in other regions.

### Fourth Embodiment

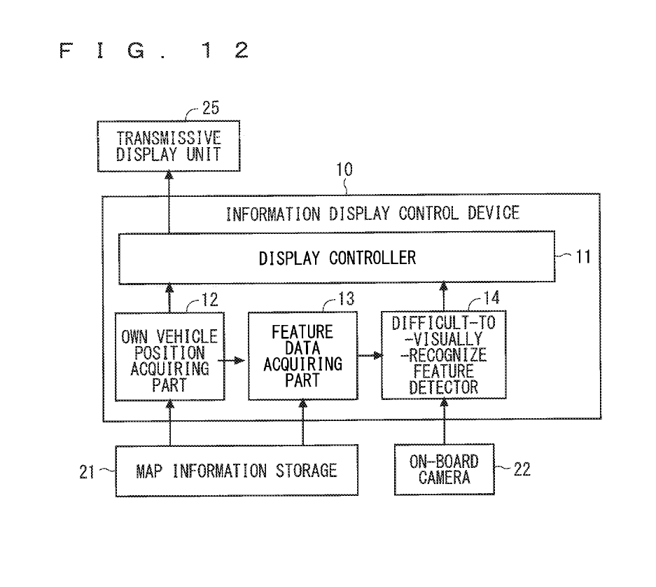

FIG. 12 is a block diagram showing the structure of an information display control system according to a fourth embodiment. Compared to the structure of the first embodiment (FIG. 1), this information display control system includes a transmissive display unit 25 instead of the display unit 20. In this system, an image captured by the on-board camera 22 is not input to the display controller 11.

The transmissive display unit 25 is a display unit belonging to a type of displaying information directly in the field of view of a driver by displaying the information on a windshield or a transparent screen that provides the driver with a sec-through view (such as a head-up display, for example).

In the first to third embodiments, to indicate the position of a difficult-to-visually-recognize feature, an image indicating the position of this difficult-to-visually-recognize feature should be displayed by being superimposed on an image captured by the on-board camera 22. However, in the case of the transmissive display unit 25, a scene viewed from a driver through a windshield becomes a background of a screen. This makes it possible to superimpose an image indicating the position of a difficult-to-visually-recognize feature on an actual scene without using an image captured by the on-board camera 22.

In this embodiment, an image indicating the existence of a difficult-to-visually-recognize feature is displayed by the transmissive display unit 25 in such a manner as to be superimposed on a position where this difficult-to-visually-recognize feature exists as viewed from a driver of an own vehicle, thereby indicating the position of the difficult-to-visually-recognize feature. FIG. 18 conceptually shows this method.

It is assumed, for example, that a ground surface S is a plane including an X axis and a Y axis, as shown in FIG. 18. If a feature F as a difficult-to-visually-recognize feature exists in a position P1 (x1, y1) on the ground surface S, the display controller 11 displays an image F1 indicating the existence of the feature F at a point of intersection on a screen SC (such as a windshield) of the transmissive display unit 25 with a line connecting a position E of an eye of a driver and the position P1 (x1, y1). In a view from the driver obtained through use of this method, the image F1 is superimposed on the position where the feature F exists, so that the driver is allowed to recognize the position where the difficult-to-visually-recognize feature exists correctly based on the position where the image F1 is displayed.

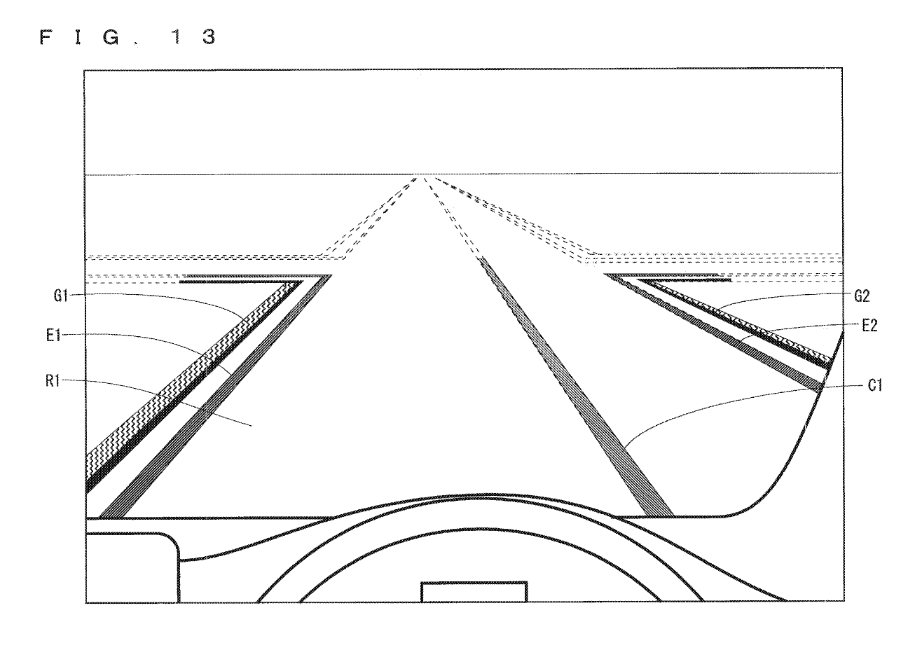

Like in the example shown in the first embodiment, if an own vehicle travels on the road R1 of FIG. 2 in the presence of snow cover, for example, an image such as that shown in FIG. 13 is projected in the field of view of a driver (a background of images indicating the road R1, the center line C1, the edge lines E1 and E2, and the side ditches G1 and G2 is an actual scene). This allows the driver of the own vehicle to easily recognize the width of the road R1 and the respective positions of the center line C1, the edge lines E1 and E2, and the side ditches G1 and G2.

FIG. 14 is a flowchart showing the operation of the information display control device 10 according to the fourth embodiment. The aforementioned operation is realized by implementation of processes shown in FIG. 14 by the information display control device 10. The processes of FIG. 14 are finished in response to an action for finishing these processes taken by a user on the information display control device 10, input of a command given from a different device instructing finish of these processes to the information display control device 10, or receipt of a command instructing finish of these processes given from a different process performed by the information display control device 10, for example.

When the information display control device 10 is started, the own vehicle position acquiring part 12 first acquires position information about an own vehicle (step S21), and the feature data acquiring part 13 acquires feature data about a feature existing in a neighborhood of the own vehicle from the map information storage 21 (step S22).

Next, the difficult-to-visually-recognize feature detector 14 analyzes an image of a surrounding of the vehicle (an image of a position where the feature exists) captured by the on-board camera 22 based on the feature data (position information about the feature) acquired by the feature data acquiring part 13, thereby determining whether or not there is a difficult-to-visually-recognize feature in a neighborhood of the own vehicle (step S23). If there is no difficult-to-visually-recognize feature in the neighborhood of the own vehicle (step S23: NO), the flow returns to step S21.

If there is a difficult-to-visually-recognize feature in the neighborhood of the own vehicle (step S23: YES), the display controller 11 makes the transmissive display unit 25 display an image indicating the position of the difficult-to-visually-recognize feature in the field of view of a driver (step S24). In a view from the driver, the image indicating the position of the difficult-to-visually-recognize feature is superimposed on an actual scene. Then, the flow returns to step S21. Specifically, the processes from steps S21 to S24 are performed repeatedly.

In the illustration of FIG. 14, the transmissive display unit 25 is applied to the information display control system of the first embodiment. Alternatively, the transmissive display unit 25 is further applicable to the respective information display control systems shown in the second and third embodiments.

### Fifth Embodiment

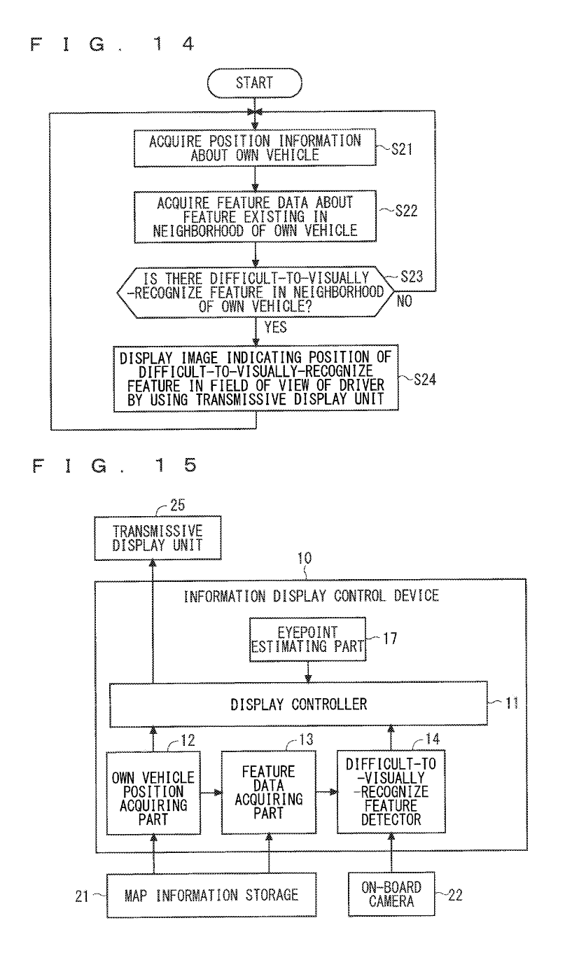

FIG. 15 is a block diagram showing the structure of an information display control system according to a fifth embodiment. Compared to the structure of the fourth embodiment (FIG. 12), this information display control system additionally includes an eyepoint estimating part 17 in the information display control device 10.

The eyepoint estimating part 17 estimates the position of an eye (eyepoint) of a driver with respect to a screen (such as a windshield) of the transmissive display unit 25. The eyepoint estimating part 17 may estimate the position of an eye of a driver by any method. For example, the position of an eye of a driver may be estimated by a method of analyzing an image of the face of the driver captured by a camera (driver monitoring camera) installed on a driver's seat. As another example, the position of an eye of a driver may be estimated simply based on the position of a driver's seat (such as the position or height of a seating surface or the inclination angle of a backrest).

In this embodiment, the display controller 11 determines a display position on a screen of the transmissive display unit 25 for an image indicating the position of a difficult-to-visually-recognize feature based on the position of an eye of a driver estimated by the eyepoint estimating part 17. Thus, the image indicating the position of the difficult-to-visually-recognize feature can be displayed in a more proper position in the field of view of the driver.

### Sixth Embodiment

A feature includes various types of features. Hence, it is likely that, if images indicating the positions of all features included in map data are displayed unlimitedly on a display unit (or transmissive display unit), the respective positions of these features will be difficult to recognize. Then, in this embodiment, a user is allowed arbitrarily set a type of a feature to be a target indicating a position in a displayed image and a condition for display of an image.

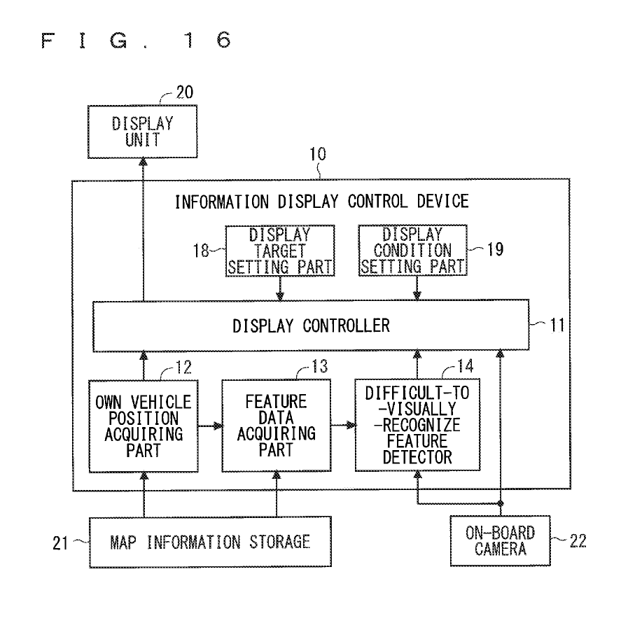

FIG. 16 is a block diagram showing the structure of an information display control system according to a sixth embodiment. Compared to the structure of the first embodiment (FIG. 1), this information display control system additionally includes a display target setting part 18 and a display condition setting part 19 in the information display control device 10.

The display target setting part 18 and the display condition setting part 19 are user interfaces operable by a user. A user can set a type of a feature to be a target indicating a position in a displayed image by using the display target setting part 18 and can set a condition for display of an image indicating the position of a feature by using the display condition setting part 19. The display target setting part 18 and the display condition setting part 19 may be devices (remote controllers, for example) attached externally to the information display control device 10.

In the sixth embodiment, the display controller 11 superimposes only an image, indicating a difficult-to-visually-recognize feature belonging to a type set by the display target setting part 18, on a captured image of a surrounding of an own vehicle. Then, the display controller 11 displays a resultant image on the display unit 20. Further, only if a condition set by the display condition setting part 19 is satisfied, the display controller 11 displays an image indicating the position of a feature on the display unit 20.

In this embodiment, a target indicating a position in a displayed image and a condition for display of an image can be set according to preference of a user. For example, a feature to be a target indicating a position in a displayed image is limited to a traffic sign or a range of display of an image indicating the position of a feature is limited. This can prevent display of an unnecessary image, so that each displayed image can be given enhanced visibility.

Compared to the structure of the information display control system of the first embodiment, the structure shown in FIG. 16 additionally includes the display target setting part 18 and the display condition setting part 19 in the information display control device 10. Alternatively, this embodiment is further applicable to the respective information display control systems shown in the second to fifth embodiments.

The embodiments of the present invention can be combined freely, or each of the embodiments can be changed or omitted, where appropriate, within the scope of the invention.

While the invention has been shown and described in detail, the foregoing description is in all aspects illustrative and not restrictive. It is therefore understood that numerous modifications and variations can be devised without departing from the scope of the invention.

### REFERENCE SIGNS LIST

10 Information display control device
11 Display controller
12 Own vehicle position acquiring part
13 Feature data acquiring part
14 Difficult-to-visually-recognize feature detector
14a Traveling interfering feature extracting part
17 Eyepoint estimating part
18 Display target setting part
19 Display condition setting part
20 Display unit
21 Map information storage
22 On-board camera
23 On-board sensor
24 Communication device
25 Transmissive display unit

1-13. (canceled)

14. An information display control system comprising:
a processor to execute a program; and
a memory to stores the program which, when executed by said processor, performs processes of:
acquiring position information about an own vehicle;
acquiring feature data including position information about a feature;
detecting a difficult-to-visually-recognize feature that is a feature existing in a position where said feature is visually recognizable from said own vehicle but in a state of being difficult to recognize visually;
extracting a traveling interfering feature that might be an interference with traveling of said own vehicle from difficult-to-visually-recognize features; and
superimposing, based on said position information about said feature included in said feature data and said position information about said own vehicle, an image indicating a position of at least one of said difficult-to-visually-recognize features and an image indicating a position and a shape of said traveling interfering feature on a captured image of a surrounding of said own vehicle and making a display unit of said own vehicle display an image obtained by said superimposing.

15. The information display control system according to claim 14, wherein
said image indicating the position of said traveling interfering feature includes an image warning about the existence of said traveling interfering feature.

16. The information display control system according to claim 14, wherein
a user is allowed to set a type of a feature to be a target indicating a position in an image, and
said processor makes said display unit display only an image indicating, among said difficult-to-visually-recognize features, said feature belonging to said type set by said user.

17. The information display control system according to claim 14, wherein
a user is allowed to set a condition for display of an image indicating a position of a feature, and
if said condition set by said user is satisfied, said processor makes said display unit display an image indicating a position of a feature.

18. The information display control system according to claim 14, wherein
said feature to be detected as a difficult-to-visually-recognize feature includes one or more of a road, a lane, and a road marking.

19. An information display control system comprising:
a processor to execute a program; and
a memory to stores the program which, when executed by said processor, performs processes of:
acquiring position information about an own vehicle;
acquiring feature data including position information about a feature;
detecting a difficult-to-visually-recognize feature that is a feature existing in a position where said feature is visually recognizable from said own vehicle but in a state of being difficult to recognize visually;
extracting a traveling interfering feature that might be an interference with traveling of said own vehicle from difficult-to-visually-recognize features; and
making a transmissive display unit display, based on said position information about said feature included in said feature data and said position information about said own vehicle, a first image indicating a position of at least one of said difficult-to-visually-recognize features and a second image indicating a position and a shape of said traveling interfering feature in such a manner that said first image is displayed in said position of said at least one of said difficult-to-visually-recognize features and said second image is displayed in said position of said traveling interfering feature as viewed from a driver of said own vehicle, said transmissive display unit providing said driver with a see-through view.

20. The information display control system according to claim 19, wherein
said processor estimates a position of an eye of said driver with respect to a screen of said transmissive display unit, and determines a display position for said first image indicating said position of said at least one of said difficult-to-visually-recognize features, based on said estimated position of said eye of said driver.

21. A method of controlling display of information, said method comprising:
acquiring position information about an own vehicle;
detecting a difficult-to-visually-recognize feature that is a feature existing in a position where said feature is visually recognizable from said own vehicle but in a state of being difficult to recognize visually;
extracting a traveling interfering feature that might be an interference with traveling of said own vehicle from difficult-to-visually-recognize features;
acquiring position information about at least one of said difficult-to-visually-recognize features; and
superimposing, based on said position information about said at least one of said difficult-to-visually-recognize features and said position information about said own vehicle, an image indicating a position of said at least one of said difficult-to-visually-recognize features and an image indicating a position and a shape of said traveling interfering feature on a captured image of a surrounding of said own vehicle and making a display unit display an image obtained by said superimposing.

22. A method of controlling display of information, said method comprising:
acquiring position information about an own vehicle;
detecting a difficult-to-visually-recognize feature that is a feature existing in a position where said feature is visually recognizable from said own vehicle but in a state of being difficult to recognize visually;
extracting a traveling interfering feature that might be an interference with traveling of said own vehicle from difficult-to-visually-recognize features;
acquiring position information about at least one of said difficult-to-visually-recognize features; and
making a transmissive display unit display, based on said position information about said at least one of said difficult-to-visually-recognize features and said position information about said own vehicle, a first image indicating a position of said at least one of said difficult-to-visually-recognize features and a second image indicating a position and a shape of said traveling interfering feature in such a manner that said first image is displayed in said position of said at least one of said difficult-to-visually-recognize features and said second image is displayed in said position of said traveling interfering feature as viewed from a driver of said own vehicle, said transmissive display unit providing said driver with a see-through view.
